(19) United States
(12) Patent Application Publication
(10) Pub. No.: US 2026/0309420 A1
(43) Pub. Date: Oct. 8, 2026

(54) DIRECT-FIRED KILN USING RECYCLED FLUE GAS

(71) Applicant: ExxonMobil Technology and Engineering Company, Spring, TX (US)

(72) Inventors: Jason D. DAVIS, Zachary, LA (US); Peter A. GORDON, Yardley, PA (US); Jonathan M. GIESEKE, Pinehurst, TX (US); Javier S. PARRA, Baton Rouge, LA (US)

(21) Appl. No.: 19/639,596

(22) Filed: Apr. 6, 2026

Related U.S. Application Data
(60) Provisional application No. 63/784,219, filed on Apr. 6, 2025.

(51) Int. Cl. F27B 7/36; F27D 19/00; F27D 21/00

(52) U.S. Cl. CPC F27B 7/36; F27D 19/00; F27D 21/0014; F27D 2019/0003; F27D 2019/0012; F27D 2019/0031

(57) ABSTRACT

An exemplary method for thermal treating a feed material in a direct-fired kiln including a combustion device, a combustion zone, a heat transfer zone, and an optional dilution zone between the combustion zone and the heat transfer zone includes supplying an oxidant stream and a fuel to the combustion device. The method includes combusting the fuel in the combustion zone to produce a gas mixture. The method includes contacting the gas mixture with the feed material in the heat transfer zone. The method includes withdrawing a flue gas stream from the heat transfer zone at a flue gas outlet. The method includes supplying a recycle portion of the flue gas stream to at least one of: the oxidant stream; the combustion zone; the optional dilution zone, and the heat transfer zone downstream of the combustion zone and/or the optional dilution zone.

### CROSS-REFERENCE TO RELATED APPLICATIONS

This application claims priority to U.S. Patent Application No. 63/784,219, filed Apr. 6, 2025, the entire contents of which are fully incorporated herein by reference as if fully set forth below.

### FIELD

This disclosure generally relates to direct-fired kiln and methods for thermally treating feed materials using direct-fired kiln. More specifically, this disclosure is directed towards direct-fired kiln with treatment temperature management and using such kiln in treating feed materials comprising oxidizable components.

### BACKGROUND

This section is intended to introduce various aspects of the art, which may be associated with exemplary embodiments of this disclosure. This discussion is believed to assist in providing a framework to facilitate a better understanding of particular aspects of this disclosure. Accordingly, it should be understood that this section should be read in this light, and not necessarily as admissions of prior art.

A kiln is an apparatus comprising an insulated chamber capable of providing temperatures sufficient to complete some process, such as hardening, drying, sintering, calcining, and/or chemical changes, inside the chamber. Kilns have been used to turn objects made from clay into pottery, tiles and bricks. Various industries use rotary kilns for pyroprocessing and to transform many other materials. For example, pyroprocessing may be used to calcine ores, such as limestone to lime for cement or produce charcoal from any suitable organic material, such as wood, bamboo or coconut.

### SUMMARY

One aspect of the disclosure provides a method for calcining a feed material in a direct-fired kiln including a combustion device, a combustion zone, a heat transfer zone, and an optional dilution zone between the combustion zone and the heat transfer zone. The method can include supplying an oxidant stream and a fuel to the combustion device. The method can also include combusting the fuel in the combustion zone to produce a gas mixture. The method can further include contacting the gas mixture with feed material in the heat transfer zone. The method can also further include withdrawing a flue gas stream from the heat transfer zone at a flue gas outlet. The method can also include supplying a recycle portion of the flue gas stream to at least one of: the oxidant stream; the combustion zone; the optional dilution zone, and the heat transfer zone downstream of the combustion zone and/or the optional dilution zone.

Another aspect of the disclosure provides a kiln for calcining a feed material. The kiln can include a combustion device. The kiln can also include an oxidant supply line configured to supply an oxidant to the combustion device. The kiln can further include a fuel line configured to supply a fuel to the combustion device. The kiln can also further include a combustion zone configured to allow combustion of the fuel in the presence of the oxidant to produce a gas mixture. The kiln can include a heat transfer zone having a feed inlet for receiving the feed material, a product outlet for discharging a calcined product, a flue gas outlet for discharging a flue gas stream, a proximal end in proximity to the combustion zone for receiving the gas mixture, and a distal end opposite to the proximal end and in proximity to the flue gas outlet. The kiln can also include an optional dilution zone between the combustion zone and the heat transfer zone. The kiln can also include a flue gas recycle line configured to supply a recycle portion of the flue gas stream to at least one of: the oxidant supply line; the combustion zone; the optional dilution zone; and the heat transfer zone downstream of the combustion zone and/or the optional dilution zone.

These and other features and attributes of the disclosed embodiments of this disclosure and their advantageous applications and/or uses will be apparent from the detailed description that follows.

### BRIEF DESCRIPTION OF THE DRAWINGS

The advantages of this disclosure are better understood by referring to the following detailed description and the attached drawings, in which:

FIG. 1 is a schematic illustration of an exemplary direct-fired rotary kiln, according to an embodiment of this disclosures;

FIG. 2 is a block diagram of an exemplary system for treating a feed material including supplying a recycled portion of a flue gas stream in a direct-fired kiln, according to an embodiment of this disclosure; and

FIG. 3 is a process flow diagram illustrating a method for treating a feed material in a direct-fired kiln, according to an embodiment of this disclosure.

It should be noted that the figures are merely examples of this disclosure and are not intended to impose limitations on the scope of this disclosure. Further, the figures are generally not drawn to scale, but are drafted for purposes of convenience and clarity in illustrating various aspects of the disclosure.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that this disclosure is not limited to particular devices or methods, which may, of course, vary. It is also to be understood that the terminology used herein is for the purpose of describing particular embodiments only, and is not intended to be limiting.

As used herein, the following terms shall have the following meanings.

As used herein, the terms “example,” exemplary,” and “embodiment,” when used with reference to one or more components, features, structures, or methods according to this disclosure, are intended to convey that the described component, feature, structure, or method is an illustrative, non-exclusive example of components, features, structures, or methods according to this disclosure. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of this disclosure.

As used herein, a “combustion zone” refers to a zone within a direct-fired kiln in which the fuel molecules reacts with an oxidant generating a flame and releasing thermal energy. The combustion zone may be part of a heat transfer zone, or may overlap with the heat transfer zone. In some examples, a heat transfer zone may immediately follow the combustion zone.

As used herein, a “direct-fired kiln” refers to a kiln that is heated by combustion of a fuel with oxidant inside the kiln to produce a hot gas mixture, and the gas mixture directly contacts with a feed material in a heat transfer zone to effect treatment of the feed material.

As used herein, a “heat transfer zone” refers to a kiln in which the feed material to be treated does not directly contact with a thermal energy source (e.g., a hot gas mixture produced by combustion of a fuel), but only directly contacts an intermediate heat transfer medium (e.g., a metal wall), which, in turn, is heated by the thermal energy source.

As used herein, a “rotary kiln” is a kiln with a refractory-lined substantially cylindrical heated vessel that rotates about a longitudinal axis and in which material is subjected to thermal treatment at elevated temperatures.

In this disclosure, a method is described as comprising at least one “step.” It should be understood that each step is an action or operation that may be carried out once or multiple times in the method, in a continuous or discontinuous fashion. Unless specified to the contrary or the context clearly indicates otherwise, multiple steps in a process may be conducted sequentially in the order as they are listed, with or without overlapping with one or more other steps, or in any other order, as the case may be. In addition, one or more or even all steps may be conducted simultaneously with regard to the same or different batch of material. For example, in a continuous process, while a first step in a process is being conducted with respect to a raw material just fed into the beginning of the process, a second step may be carried out simultaneously with respect to an intermediate material resulting from treating the raw materials fed into the process at an earlier time in the first step. Preferably, the steps are conducted in the order described.

Unless otherwise indicated, all numbers indicating quantities in this disclosure are to be understood as being modified by the term “about” in all instances. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for acquiring the measurement.

If there is any conflict in the usages of a word or term in this specification and one or more patent or other documents that may be incorporated herein by reference, the definitions that are consistent with this specification should be adopted for the purposes of understanding this disclosure.

In the following detailed description section, specific embodiments of this disclosure are described. However, to the extent that the following description is specific to a particular embodiment or a particular use of this disclosure, this is intended to be for exemplary purposes only and simply provides a description of the exemplary embodiments. Accordingly, the disclosure is not limited to the specific embodiments described below, but rather, include all alternatives, modifications, and equivalents falling within the true spirit and scope of the appended claims.

### Overview

Direct-fired rotary kilns generally include a refractory lined cylindrical shell and a combustion device, such as a burner. In this disclosure, a burner can include one, two, three, or even more burners. The combustion of a fuel with an oxidant supplied to the burner at the burner inside the kiln produces a hot gas mixture. On directly contacting the feed material, the hot gas mixture provides the necessary energy to heat a feed material desired to be treated (e.g., calcined, sintered, or converted) inside the kiln. Excess oxygen can be desirably present in the hot gas mixture to ensure full destruction of the fuel source and minimize combustion byproducts. The combustion at the burner and the flow of the gas mixture heats the kiln to the desired temperatures at various locations inside the kiln. Following heat exchange the gas mixture, and any resultant volatile material generated from the process can be withdrawn from the kiln as a flue gas stream via a pressure gradient generated by an induced draft fan. Outside the kiln this flue gas stream can go through a variety of different treatment steps to recover any usable heat and adequate processing for discharge to the atmosphere.

However, if the feed material is combustible or oxidizable, or the process generates combustible by-products, then the temperature at various locations can increase beyond the desired target range due to the excess oxygen present. This poses a particular challenge for the heating of feed material that may react with oxygen at elevated temperatures in the presence of oxygen. If the direct fired kiln is operated under vacuum conditions, oxygen ingress can further exacerbate the temperature control issue.

As one example, woodchips as a feed material may be fed into an inlet located at the upper end of a direct-fired rotary kiln to produce charcoal as a product. As the direct-fired rotary kiln rotates, the woodchips move downwards through a thermal zone due to gravity and rotation. As the wood chips get closer and closer to the combustion zone, the temperature that the woodchips experience may gradually increase. When the woodchips reach a boundary between a combustion zone and a heat transfer zone, the temperature may reach a highest value. However, in order to combust the natural gas fuel used to heat the kiln, an excessive amount of oxygen may be used to ensure that the fuel is spent. The hot gas mixture produced in the combustion zone therefore contains some free oxygen. Thus, when that free oxygen gets into the heat transfer zone, the oxygen may oxidize the woodchips at least partially. When heated at high temperature, the woodchips may also produce various organic material vapor, which may be easily combusted at high heat. The combustion of the wood, the charcoal product and any organic material vapor generated by processing of the wood chips, on contacting residual oxygen, produces additional heat. This additional heat can cause temperature excursion at various locations inside the kiln, resulting in production of less amount of desirable product with less than desirable quality.

The methods and system of this disclosure include supplying a recycle portion of a flue gas stream withdrawn from a direct-fired kiln to one or more of (i) the oxidant supply line to a combustion device; (ii) the combustion zone; (iii) the optional dilution zone; and (iv) the heat transfer zone, of the kiln, thereby controlling and mitigating undesirable temperature excursion in the heat transfer zone.

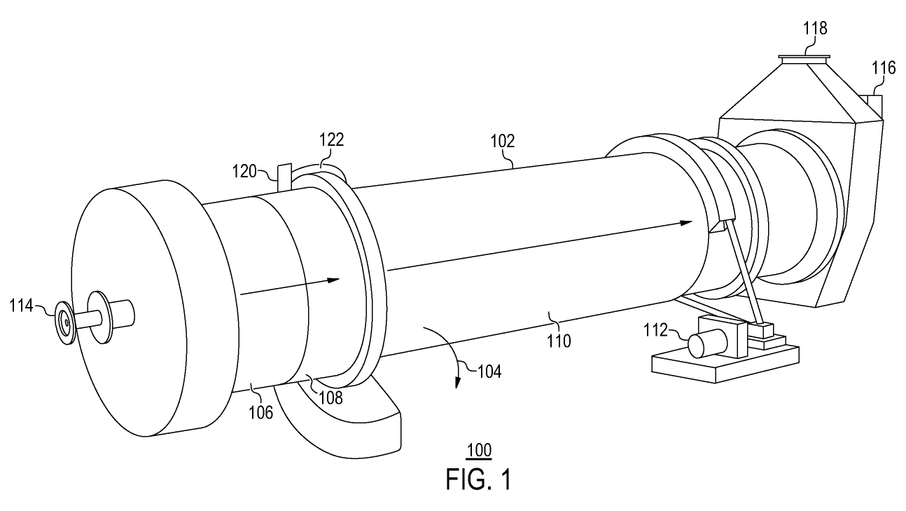

Referring now to FIG. 1, an exemplary direct-fired rotary kiln 100 is illustrated. The direct-fired rotary kiln 100 includes a substantially cylindrical shell 102. For example, the shell 102 may be a drum constructed from any suitable material, such as carbon steel. The direct-fired rotary kiln 100 can include a refractory lining on the inside of the shell 102 to protect the shell 102 from high temperatures.

The shell 102 can includes a combustion zone 106, an optional dilution zone 108, and a heat transfer zone 110. In the combustion zone, the combustion of the fuel gas with the oxidant supplied to the combustion device (“burner”) undergoes combustion reactions, typically generating a flame and producing a hot gas mixture. Thus, the combustion zone can be considered as the zone in which a burner flame exists. The hot gas mixture flows inside the kiln from the combustion zone to the optional dilution zone, and to the heat transfer zone, before it reaches a flue gas outlet, where it is withdrawn from the heat transfer zone. The heat transfer zone is the zone where the feed material directly contacts the flowing flue gas to effect the desired treatment of the feed material inside the kiln. In various embodiments, the combustion zone 106 may be part of the heat transfer zone 110, or partly overlaps with the heat transfer zone 110. In some embodiments, the heat transfer zone 110 may immediately follow the combustion zone 106. Thus, the dilution zone 108 is optional, and may be excluded from the kiln 100.

The direct-fired rotary kiln 100 can include a drive motor 112 to rotate the shell 102. The direct-fired rotary kiln 100 includes a combustion device 114. For example, the combustion device 114 may be a burner, such as a natural gas burner that combusts natural gas with air. In various embodiments, the combustion device 114 may be coupled to both an oxidant supply line configured to supply an oxidant to the combustion device 114 and a fuel line configured to supply a fuel to the combustion device 114. In various embodiments, the oxidant can be, e.g.: air, compressed air; oxygen-enriched air; air diluted with an inert gas such as steam, N2; and the like. In various embodiments, the fuel can be, e.g., hydrogen, natural gas, liquified petroleum gas, propane, butanes, and the like, and any mixtures of two or more thereof. The a combustion zone 106 is configured to allow combustion of the fuel in the presence of the oxidant to produce a gas mixture having a desired high temperature.

The direct-fired rotary kiln 100 can include a feed inlet 116 for receiving a feed material to be treated. For example, the feed material may be, e.g., woody materials such as wood chips, any solid material comprising an organic component, or a carbonaceous material. In various embodiments, the feed inlet 116 is located in the heat transfer zone 110, preferably in proximity to an end of the heat transfer zone.

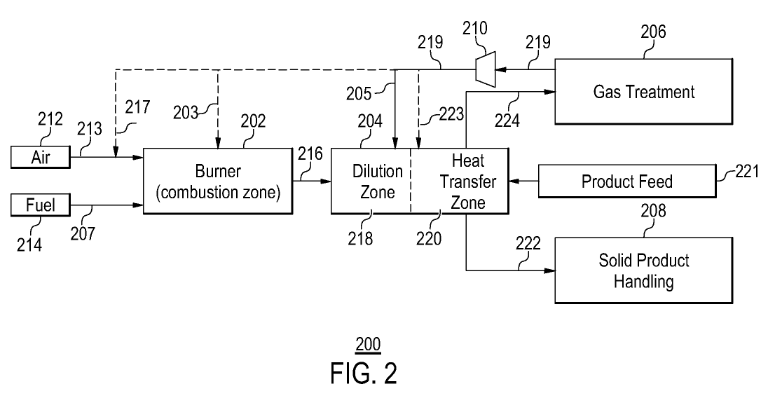

The direct-fired rotary kiln 100 can include a flue gas outlet 118. From the flue gas outlet 118, a flue gas stream can be withdrawn from kiln 100. In various embodiments, the flue gas may be redirected to a gas treatment unit (not shown), as described below with respect to FIG. 2. As shown in FIG. 1, in various embodiments, the flue gas outlet 118 can be located at the heat transfer zone 110, preferably in proximity to an end of the heat transfer zone 110.

In various embodiments, the direct-fired rotary kiln 100 can include a dilution zone between the combustion zone and the heat transfer zone.

In various embodiments, the direct-fired kiln 100 can include a flue gas recycle line. In certain embodiments, the flue gas recycle line feeds a recycle portion of the flue gas stream to the dilution zone via a recycled gas inlet located at the dilution zone 108. Alternatively or additionally, the flue gas recycle line may also feed a recycle portion of the flue gas stream to the oxidant supply line. Still alternatively or additionally, the flue gas recycle line may also feed a recycle portion of the glue gas stream to the heat transfer zone, preferably a location in the heat transfer zone in proximity to and downstream of the combustion zone and/or the dilution zone. In a preferred embodiment, the kiln has a dilution zone, and the recycle portion of the flue gas stream is supplied to one or more locations of the dilution zone. In various embodiments, a portion of a treated recycled flue gas may be supplied as the recycle portion of the flue gas stream via the recycle flue gas line. As shown, the recycle portion of the flue gas stream is supplied to a dilution zone via a recycled gas inlet 120.

In various embodiments, the heat transfer zone 110 can also include a product outlet 122 for discharging a treated (e.g., calcined, sintered, or reacted) product. For example, the treated product may be charcoal. In some embodiments, the heat transfer zone 110 can also include a proximal end in proximity to the combustion zone 106 for receiving the gas mixture, and a distal end opposite to the proximal end and in proximity to the flue gas outlet 118. In some embodiments, the heat transfer zone 110 may be a rotary heat transfer zone 110. In some embodiments, the heat transfer zone 110 tilts upwards from the proximal end to the distal end. Alternatively, in some embodiments, the heat transfer zone 110 tilts downwards from the proximal end to the distal end.

In certain embodiments, an organic material-containing feed material such as a woody material may be input into the direct-fired rotary kiln 100 via the feed inlet 116. The direct-fired rotary kiln 100 can rotate as indicated by an arrow 104 such that the feed material is tumbled and brought through the heat transfer zone 110 towards the dilution zone 108 and combustion zone 106. As the feed material is being processed, various parameters may be adjusted in real-time, such as the air/fuel ratio for the combustion device 114, or the amount and/or flow rate of recycled flue gas supplied through the recycle gas supply line. These adjustments may reduce the concentration of oxygen in the heat transfer zone and/or the dilution zone and/or the combustion zone, preventing or mitigation undesirable temperature excursions within the heat transfer zone 110 caused by residual oxygen oxidizing the feed material or a byproduct from processing the feed material. In addition, the recycle portion of the flue gas stream can be supplied at a temperature lower than that in the combustion zone, the combustion zone, and/or the heat transfer zone, thereby lower the temperature in these zones as well. The better temperature control can lead to better processing of the feed material, resulting in higher yields of the treated product with higher quality.

Those skilled in the art will appreciate that the exemplary direct-fired rotary kiln 100 of FIG. 1 is susceptible to modification without altering the technical effect provided by this disclosure. In practice, the exact manner in which the direct-fired rotary kiln 100 is implemented will depend, at least in part, on the details of the specific implementation. For example, in some embodiments, some of the blocks shown in FIG. 1 may be altered or omitted from the direct-fired rotary kiln 100 and/or new blocks may be added to the direct-fired rotary kiln 100. For example, in some embodiments, the direct-fired rotary kiln 100 may not include a dilution zone 108. In these embodiments, the inlet 120 may be located within the heat transfer zone 110, the oxidant supply line connected to the combustion device 114, or the combustion zone 106. For example, the flue gas recycle line may be configured to supply a recycle portion of the flue gas stream to the heat transfer zone 110 immediately downstream of the combustion zone 106 in the flow direction of the gas mixture. In some embodiments, the direct-fired rotary kiln 100 is a counter-current kiln including a feed inlet 116 in proximity to a distal end of the heat transfer zone 110 and in proximity to the flue gas outlet 118, and a product outlet 122 in proximity to a proximal end of the heat transfer zone 110, where the proximal end is in proximity to the combustion zone 106. Alternatively, in some embodiments, the direct-fired rotary kiln 100 is a co-current kiln, the feed inlet 116 is in proximity to the proximal end of the heat transfer zone 110, and the product outlet 122 is in proximity to the distal end of the heat transfer zone 110 and in proximity to the flue gas outlet 118, where the proximal end is in proximity to the combustion zone 106.

In some embodiments, the direct-fired rotary kiln 100 may also include various sensors and/or controllers. In various embodiments, the sensors may include any combination of temperature sensors, oxygen sensors, and pressure sensors. For example, the direct-fired rotary kiln 100 may include a temperature sensor configured to measure a temperature in the combustion zone and/or a temperature sensor configured to measure a temperature in the heat transfer zone and/or a temperature sensor configured to measure a temperature in the dilution zone. The direct-fired rotary kiln 100 may also include a controller configured to control an amount and/or flow rate of the recycle portion of the flue gas stream in the flue gas recycle line using at least partly the measured temperature in the combustion zone and/or the measured temperature in the heat transfer zone and/or the measured temperature in the dilution zone. In some embodiments, the direct-fired rotary kiln 100 may further include ) an O₂ sensor configured to measure an O₂ concentration in the combustion zone and/or an O₂ sensor configured to measure an O₂ concentration in the heat transfer zone and/or an O₂ sensor configured to measure an O₂ concentration in the dilution zone. In these embodiments, the direct-fired rotary kiln 100 also includes a controller configured to control an amount and/or flow rate of the recycle portion of the flue gas stream in the flue gas recycle line using at least partly the measured O₂ concentration in the combustion zone and/or the measured O₂ concentration in the heat transfer zone and/or the measured O₂ concentration in the dilution zone. In some embodiments, the direct-fired rotary kiln 100 may include a pressure sensor configured to measure a pressure in the combustion zone, and/or a pressure sensor configured to measure a pressure in the heat transfer zone, and/or a pressure sensor configured to measure a pressure in the dilution zone. In these embodiments, the direct-fired rotary kiln 100 also includes a controller configured to control an amount of the recycle portion of the flue gas stream in the flue gas recycle line using at least partly the measured pressure in the combustion zone, and/or the measured pressure in the heat transfer zone, and/or the measured pressure in the dilution zone. Furthermore, in some embodiments, the direct-fired rotary kiln 100 includes a flue gas treatment subsystem in fluid communication with the flue gas outlet 118 and the flue gas recycle line connected to the inlet 120. In various embodiments, the flue gas treatment subsystem may include at least one of a particle removing device configured to abate particulates present in the flue gas stream, a heat exchanger configured to reduce a temperature of the flue gas stream, and/or a sulfur removing device configured to abate a sulfur-containing material from the flue gas stream. One skilled in the art also understands that a stationery kiln may be used in the methods and systems of this disclosure as well.

FIG. 2 is block diagram of an exemplary system 200 for treating (e.g., calcining, sintering, converting) a feed material. The system 200 comprises a combustion zone 202 including a combustion device. For example, the combustion device 202 may be a burner, such as a natural gas burner. The system 200 can include a kiln body 204 coupled to the combustion device 202. Kiln body 204 can include a heat transfer zone 220 and an optional dilution zone 218 between the combustion zone 202 and the heat transfer zone 220. The heat transfer zone can be preferably rotatable, although it may be stationary in certain embodiments. The system 200 can also include a gas treatment unit 206 fluidically coupled to the kiln shell 204. The system 200 can also include a solid product handling unit 208. The system 200 can also include a compressor/blower 210 coupled to the gas treatment unit 206. The compressor/blower 210 can also further be coupled to any combination of two or more of the combustion device 202 (via line 203), the dilution zone 218 (via line 205) if the dilution zone 218 is present, the heat transfer zone 220 (via line 223), the oxidant supply line 213 (via line 217). Preferably the dilution zone 218 is present, and at least a portion of the recycle portion of the flue gas stream is supplied from the compressor/blower 210 to the dilution zone 218.

In various embodiments, the combustion device 202 receives an oxidant (e.g., air) from an oxidant source 212 via an oxidant supply line 213 and a fuel from a fuel source 214 via a fuel supply line 207. The fuel combusts with the oxidant in the combustion zone to produce a hot gas mixture in the combustion zone. The hot gas mixture flows into the heat transfer zone, contacts the feed material to effect thermal treatment thereof. In various embodiments, excess oxygen may be present in the gas mixture to ensure full destruction of the fuel source and minimize combustion byproducts.

In some embodiments, the dilution zone 218 mixes the hot gas stream 216 with recycle portion of flue gas 219, which mixture is then sent into the heat transfer zone 220 for heating product feed 221. The treated product 222 can be output to the solid product handling unit 208 for further processing.

In various embodiments, after transferring its heat to the product feed 221, the gas mixture inside the kiln exits the kiln via a flue gas outlet at the heat transfer zone as a flue gas stream 224, which can be sent to a gas treatment unit 206. The flue gas stream 224 may then be treated and one or more components removed therefrom. In various embodiments, the gas treatment unit 206 may include a particle removing device configured to abate particulates present in the flue gas stream 224, a heat exchanger configured to reduce a temperature of the flue gas stream 224, and/or a sulfur removing device configured to abate a sulfur-containing material from the flue gas stream 224, among other devices. A portion of resulting treated gas mixture can be used as the recycle portion of flue gas stream 219, sent to the compressor/blower 210, which feeds the recycle portion of flue gas 219 into one or more of the dilution zone, the combustion zone 202, the heat transfer zone, and the oxidant stream supply line. The addition of the recycle portion of flue gas stream 219 back into the kiln prevents uncontrollable temperature excursions by raising the thermal mass and reduce oxygen partial pressure. Furthermore, the recycle portion of flue gas stream 219 can provide a means of pressure control. The amount of recycle portion of flue gas stream 219 that is fed back into the kiln at various locations may be based on various parameters, including pressure, temperature, and excess oxygen partial pressure. In various embodiments, the recycle portion of the flue gas stream 219 may have a temperature ranging from, e.g., ambient temperature to e.g., 300 °C, preferably no higher than 150 °C, more preferably no higher than 100 °C. A lower temperature of the recycle portion of the flue gas stream can be more effective in reducing a temperature excursion inside the kiln.

In various embodiments, the amount and/or the flow rate of the fuel and/or the oxidant may be adjusted to control the energy output from the combustion device, thereby control the temperature in the combustion zone, the optional dilution zone, and/or the heat transfer zone. Temperature sensors and/or oxygen sensors may be located in the combustion zone 106, the dilution zone 108 and/or the heat transfer zone 110. Readings of the temperature sensors may be used to adjust the amount and/or flow rate of the fuel and/or the oxidant supplied to the combustion device. Excess oxygen levels in the gas mixture (i.e., in the combustion zone, the dilution zone, and/or the heat transfer zone) may be controlled partly via adjusting the ratio of the oxidant and fuel supplied to the combustion device. Excess oxygen levels of oxygens in the gas mixture can be also controlled via adjusting the amount and/or flow rate of the recycle portion of the flue gas stream supplied to the kiln at the various locations as described above. Readings of the oxygen sensors can be used for such adjustments. Pressure may be controlled via a pressure sensor in the kiln working in tandem with a fan in flue gas withdrawing line 224.

Those skilled in the art will appreciate that the exemplary system 200 of FIG. 2 is susceptible to modification without altering the technical effect provided by this disclosure. In practice, the exact manner in which the system 200 is implemented will depend, at least in part, on the details of the specific implementation. For example, in some embodiments, some of the blocks shown in FIG. 2 may be altered or omitted from the system 200 and/or new blocks may be added to the system 200. For example, in some embodiments, the dilution zone 218 may be excluded and replaced with an extension of the heat transfer zone 220. In various embodiments, the flue gas recycle line 219 may only be coupled to the dilution zone 218 or heat transfer zone 220, with the dashed lines being excluded.

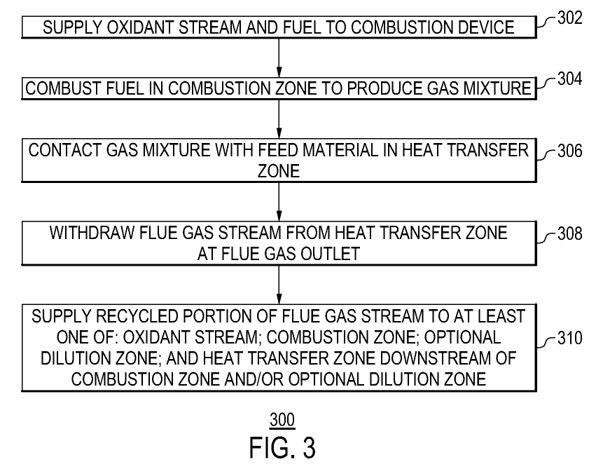

FIG. 3 is a process flow diagram of a method 300 for treating (e.g., calcining, sintering, converting) a feed material in a direct-fired kiln. In various examples, the method 300 may be implemented using the system 200 of FIG. 2 and/or in the direct-fired rotary kiln 100 of FIG. 1. For example, the direct-fired kiln may include a combustion device, a combustion zone, a heat transfer zone, and an optional dilution zone between the combustion zone and the heat transfer zone. In various preferred embodiments, the direct-fired kiln can include a rotary body including the heat transfer zone. In some embodiments, the direct-fired kiln can be a counter-current kiln including a feed inlet in proximity to a distal end of the heat transfer zone and in proximity to the flue gas outlet, and a product outlet in proximity to a proximal end of the heat transfer zone, wherein the proximal end is in proximity to the combustion zone and/or the dilution zone. In some embodiments of a counter-current kiln, the heat transfer zone tilts upward from the proximal end to the distal end. In some embodiments, the direct-fired kiln can be a co-current kiln including a feed inlet in proximity to a proximal end of the heat transfer zone, and a product outlet in proximity to a distal end of the heat transfer zone and in proximity to the flue gas outlet, wherein the proximal end is in proximity to the combustion zone and/or the dilution zone. In some other embodiments of a co-current kiln, the heat transfer zone tilts downward from the proximal end to the distal end.

At block 302, an oxidant stream and a fuel are supplied to a combustion device. For example, the combustion device may be a natural gas burner.

At block 304, the fuel is combusted in a combustion zone by reacting with the oxidant to produce a gas mixture. For example, the fuel may be combust with oxygen in the air to produce a flame and hot gas mixture.

At block 306, the gas mixture contacts with a feed material in the heat transfer zone. For example, the feed material can comprise an organic material or a carbonaceous material, or both. In some embodiments, the feed material can comprise a material that is capable of reacting with molecular oxygen, thereby releasing thermal energy. In various embodiments, the feed material is at least partly converted into a byproduct under the operating conditions of the direct-fired kiln, and a byproduct of the treatment may be capable of reacting with molecule oxygen under the operation conditions of the direct-fired kiln, thereby releasing thermal energy. In some preferred embodiments, the heat transfer zone has an absolute pressure within the range of 95 kPa to 102 kPa i.e., slightly below, next to, or above ambient pressure, preferably from 98 kPa to ambient pressure, still more preferably from 100 kPa to ambient pressure, still more preferably from 105 kPa to ambient pressure. In some preferably embodiments, the heat transfer zone has an absolute pressure ranging from P(a) – 249 pascals to P(a), preferably from P(a) – 200 pascal to P(a) – 50 pascal, where P(a) is ambient pressure, i.e., slightly below ambient pressure. Such pressure slightly below ambient pressure prevents undesirable gaseous components from outgas into the ambient environment without causing excessive oxygen ingress into the kiln from the ambient. In various embodiments, the heat transfer zone operates at a temperature within the range from 400 to 1300 °C, or from 500 to 1000 °C, or from 600 to 800 °C, depending on the feed material and the desired product.

At block 308, a flue gas stream can be withdrawn from the heat transfer zone at a flue gas outlet. For example the flue gas stream may then be sent to a gas treatment unit for processing before recycling a portion thereof.

At block 310, a recycle portion of the flue gas stream can be supplied to at least one of an oxidant stream; a combustion zone; an optional dilution zone, and a heat transfer zone downstream of the combustion zone and/or the optional dilution zone. In some embodiments, the direct-fired kiln is free of the dilution zone, and the recycle portion of the flue gas stream can be supplied to the oxidant supply line, the combustion zone, and/or the heat transfer zone immediately downstream of the combustion zone in the flow direction of the gas mixture. In some embodiments, the recycle portion of the flue gas stream has a temperature at least 100 °C (or at least 200 °C, at least 300°C, at least 500 °C) lower than the average temperature in the combustion zone. In some embodiments, the recycle portion of the flue gas stream has a temperature that is no higher than 300°C, or no higher than 200 °C, or no higher than 150 °C. In some embodiments, the recycle portion of the flue gas stream can have a temperature that is no higher than 100 °C. In some embodiments, the heat transfer zone can operate at an average temperature ranging from T(pd) – 100 °C to T(pd) + 100 °C, wherein T(pd) is a predetermined temperature, as a result of the use of the methods and systems of this disclosure. In some embodiments, temperature fluctuation range driven by a swing in ambient and cooling water temperature includes a change of 25°C around a mean value.

In some embodiments, the recycle portion of the flue gas stream can have a partial pressure of oxygen that is no higher than 5 kPa. In some embodiments, the recycle portion of the flue gas stream has a partial pressure of oxygen that ranges from 0 to 2 kPa, such as from 200 pascal to 1800 pascal, or from 500 pascal to 1500 pascal, or from 800 to 1000 pascal. In certain preferred embodiments, the recycle portion of the flue gas stream can have a partial pressure of oxygen that ranges from p(O₂-a) – 750 pascal to p(O₂-a) + 750 pascal, or from p(O₂-a) – 500 pascal to p(O₂-a) + 500 pascal, or from p(O₂-a) – 250 pascal to p(O₂-a) + 250 pascal, or from p(O₂-a) – 100 pascal to p(O₂-a) + 100 pascal, where p(O₂-a) is average partial pressure of oxygen in the recycle portion of the flue gas stream. A low oxygen partial pressure in the recycle portion of the flue gas stream is highly advantageous to control the overall oxygen partial pressure in the kiln, and thereby control temperature excursions in the kiln. A steady partial pressure in the recycle portion of the flue gas stream is highly advantageous to achieve a high degree of precision in controlling the overall oxygen partial pressure in the kiln, and thereby controlling temperature excursions in the kiln.

In some embodiments, supplying the recycle portion of the flue gas stream can further include at least one of: abating particulates present in the flue gas stream, reducing a temperature of the flue gas stream, and scrubbing a sulfur-containing material from the flue gas stream. In these embodiments, supplying the recycle portion of the flue gas stream can also include obtaining the recycle portion from the flue gas stream. In some embodiments, supplying the recycle portion of the flue gas stream can further include increasing a pressure of the recycle portion before the recycle portion reaches the at least one of: the oxidant stream; the combustion zone; the optional dilution zone; and the heat transfer zone downstream of the combustion zone and/or the optional dilution zone.

Those skilled in the art will appreciate that the exemplary method 300 of FIG. 3 is susceptible to modification without altering the technical effect provided by this disclosure. In practice, the exact manner in which the method 300 is implemented will depend, at least in part, on the details of the specific implementation. For example, in some embodiments, some of the blocks shown in FIG. 3 may be altered or omitted from the method 300 and/or new blocks may be added to the method 300. For example, in various embodiments, the method 300 may include measuring a temperature in the combustion zone and/or a temperature in the heat transfer zone and/or a temperature in the optional dilution zone.

In certain embodiments, the methods of this disclosure can comprise:

(VI) measuring a temperature in the combustion zone, or a temperature in the heat transfer zone, or a temperature in the optional dilution zone, or any combination thereof; and

(VIII) controlling an amount, or a flow rate, or both, of the recycle portion of the flue gas stream in step (V) according to at least partly the measured temperature, such that a variation of the temperature in the combustion zone is maintained in a predetermined range of deltaT1, or a variation of the temperature in the heat transfer zone is maintained in a predetermined range of deltaT2, or a variation of the temperature in the optional dilution zone is maintained in a predetermined range of deltaT3, or any combination thereof.

In certain embodiments of the methods of this disclosure, during step (I) of supplying an oxidant stream and a fuel to the combustion device, at least for a duration of one hour (e.g., at least 2 hours, 5 hours, 10 hours, 24 hours), the supply of the fuel and the supply of the oxidant stream is maintained substantially steady. In such embodiments, any temperature excursions in the kiln, particularly in the heat transfer zone, can be controlled only by the supply of the recycle portion of the flue gas stream into one or more of the oxidant supply line, the combustion zone, the dilution zone, and the heat transfer zone.

In certain embodiments of the methods of this disclosure, during step (I), the recycle portion of the flue gas stream is not supplied to the oxidant stream, or the combustion zone, or both. In such embodiments, the recycle portion of the flue gas stream is only supplied to the dilution zone (if present) and/or the heat transfer zone. Without intending to be bound by a particular theory, it is believed that this can reduce the disturbance to the combustion device and the combustion of the fuel in the combustion zone, resulting in more precise and more reliable temperature control in the heat transfer zone.

In certain preferred embodiments of the methods of this disclosure, at least one of the following is met: deltaT1 ≤ 100 °C (preferably deltaT1 ≤ 50 °C); deltaT2 ≤ 100 °C (preferably deltaT2 ≤ 50 °C); and deltaT3 ≤ 100 °C (preferably deltaT3 ≤ 50 °C).

In certain embodiments, the methods may further comprise:

(IX) measuring an oxygen (O₂) concentration in the combustion zone, or an O₂ concentration in the heat transfer zone, or an O₂ concentration in the optional dilution zone, or any combination thereof, and

(X) controlling an amount or a flow rate of the recycle portion of the flue gas stream in step (V) according to at least partly the measured O₂ concentration in the combustion zone, or the measured O₂ concentration in the heat transfer zone, or the measured O₂ concentration in the optional dilution zone, or the combination thereof, such that a variation of O₂ concentration in the combustion zone is maintained in a predetermined range of deltap(O₂)1 or a variation of O₂ concentration in the heat transfer zone is maintained in a predetermined range of deltap(O₂)2 or a variation of the O₂ concentration in the optional dilution zone is maintained in a predetermined range of deltap(O₂)3. In preferred embodiments, deltap(O₂)1 ≤ 750 pascal (preferably deltap(O₂)1 ≤ 500 pascal; preferably deltap(O₂)1 ≤ 250 pascal); deltap(O₂)2 ≤ 750 pascal (preferably deltap(O₂)2 ≤ 500 pascal; preferably deltap(O₂)2 ≤ 250 pascal); and deltap(O₂)3 ≤ 750 pascal (preferably deltap(O₂)3 ≤ 500 pascal, preferably deltap(O₂)3 ≤ 250 pascal).

In this manner, the disclosure described herein provide a practical application that directly improves the efficiency and temperature stability of direct-fired kilns. The disclosure thus further enables direct-fired kilns to produce higher quality products with higher yields.

Although embodiments herein are described with respect to calcination of organic materials, one with skilled in the art will readily recognize that the disclosure described herein is also suitable for applications in other areas.

It is intended that the foregoing detailed description be understood as an illustration of selected forms that this disclosure can take and not as a definition of this disclosure. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented.

### Embodiments of Present Disclosure

In one or more embodiments, this disclosure may be susceptible to various modifications and alternative forms, such as the following embodiments as noted in paragraphs 1 to 40:
1. A method for calcining a feed material in a direct-fired kiln including a combustion device, a combustion zone, a heat transfer zone, and an optional dilution zone between the combustion zone and the heat transfer zone, the method including supplying an oxidant stream and a fuel to the combustion device; combusting the fuel in the combustion zone to produce a gas mixture; contacting the gas mixture with the feed material in the heat transfer zone; withdrawing a flue gas stream from the heat transfer zone at a flue gas outlet; and supplying a recycle portion of the flue gas stream to at least one of: (a) the oxidant stream; (b) the combustion zone; (c) the optional dilution zone, and (d) the heat transfer zone downstream of the combustion zone and the optional dilution zone.
2. The method of paragraph 1, where the direct-fired kiln includes the optional dilution zone, and in supplying the recycle portion, the recycle portion of the flue gas stream is supplied to at least the optional dilution zone.
3. The method of paragraph 1, where the direct-fired kiln is free of the optional dilution zone, and in supplying the recycle portion, the recycle portion of the flue gas stream is supplied to the heat transfer zone immediately downstream of the combustion zone in a flow direction of the gas mixture.
4. The method of paragraph 1, where the direct-fired kiln includes a rotary body including the heat transfer zone.
5. The method of paragraph 4, where the direct-fired kiln is a counter-current kiln including a feed inlet in proximity to a distal end of the heat transfer zone and in proximity to the flue gas outlet, and a product outlet in proximity to a proximal end of the heat transfer zone, where the proximal end is in proximity to the combustion zone or the optional dilution zone.
6. The method of paragraph 5, where the heat transfer zone tilts upward from the proximal end to the distal end.
7. The method of paragraph 4, where the direct-fired kiln is a co-current kiln including a feed inlet in proximity to a proximal end of the heat transfer zone, and a product outlet in proximity to a distal end of the heat transfer zone and in proximity to the flue gas outlet, where the proximal end is in proximity to the combustion zone or the optional dilution zone.
8. The method of paragraph 5, where the heat transfer zone tilts downward from the proximal end to the distal end.
9. The method of any of paragraphs 1-8, where the heat transfer zone has an absolute pressure ranging from 95 kilopascals (kPa) to 102 kPa.
10. The method of any of paragraphs 1-8, where the heat transfer zone has an absolute pressure ranging from P(a) – 249 pascals to P(a), where P(a) is ambient pressure.
11. The method of any of paragraphs 1-10, where the heat transfer zone operates at an average temperature ranging from T(pd) – 100 °C to T(pd) + 100 °C, where T(pd) is a predetermined temperature.
12. The method of any of paragraphs 1-11, where in supplying the recycle portion of the flue gas stream, the recycle portion of the flue gas stream has a temperature that is no higher than 300 °C.
13. The method of any of paragraphs 1-12, where in supplying the recycle portion of the flue gas stream, the recycle portion of the flue gas stream has a temperature that is no higher than 150 °C.
14. The method of any of paragraphs 1-12, where in supplying the recycle portion of the flue gas stream, the recycle portion of the flue gas stream has a temperature that is no higher than 100 °C.
15. The method of any of paragraphs 1-14, where in supplying the recycle portion of the flue gas stream, the recycle portion of the flue gas stream has a partial pressure of oxygen that is no higher than 5 kPa.
16. The method of any of paragraph 15, wherein in supplying the recycle portion of the flue gas stream, the recycle portion of the flue gas stream has a partial pressure of oxygen that ranges from 0 to 2 kPa.
17. The method of any of paragraphs 1-16, where the recycle portion of the flue gas stream has a partial pressure of oxygen that ranges from p(O₂-a) – 750 pascal to p(O₂-a) + 750 pascal, where p(O₂-a) is average partial pressure of oxygen in the recycle portion of the flue gas stream.
18. The method of any of paragraphs 1-17, further including measuring a temperature in the combustion zone, or a temperature in the heat transfer zone, or a temperature in the optional dilution zone, or any combination thereof; and controlling an amount and/or a flow rate of the recycle portion of the flue gas stream in supplying the recycle portion according to at least partly the measured temperature, such that a variation of the temperature in the combustion zone is maintained in a predetermined range of deltaT1, or a variation of the temperature in the heat transfer zone is maintained in a predetermined range of deltaT2, or a variation of the temperature in the optional dilution zone is maintained in a predetermined range of deltaT3, or any combination thereof.
19. The method of any of paragraphs 1 to 18, where during the supplying of the oxidant stream, at least for a duration of one hour, maintaining the supply of the fuel and the supply of the oxidant stream substantially steady.
20. The method of paragraph 18 or 19, where during the supplying of the oxidant stream, the recycle portion of the flue gas stream is not supplied to the oxidant stream and/or the combustion zone.
21. The method of paragraph 19 or paragraph 20, where at least one of the following is met: deltaT1 ≤ 100 °C; deltaT2 ≤ 100 °C; and deltaT3 ≤ 100 °C.
22. The method of any of paragraphs 1-21, further including measuring an oxygen (O₂) concentration in the combustion zone, or an O₂ concentration in the heat transfer zone, or an O₂ concentration in the optional dilution zone, or any combination thereof, and controlling an amount or a flow rate of the recycle portion of the flue gas stream in supplying the recycle portion of the flue gas stream according to at least partly the measured O₂ concentration in the combustion zone, or the measured O₂ concentration in the heat transfer zone, or the measured O₂ concentration in the optional dilution zone, or the combination thereof, such that a variation of O₂ concentration in the combustion zone is maintained in a predetermined range of deltap(O₂)1 and/or a variation of O₂ concentration in the heat transfer zone is maintained in a predetermined range of deltap(O₂)2 and/or a variation of the O₂ concentration in the optional dilution zone is maintained in a predetermined range of deltap(O₂)3.
23. The method of paragraph 22, where at least one of the following is met: deltap(O₂)1 ≤ 750 pascal; deltap(O₂)2 ≤ 750 pascal; and deltap(O₂)3 ≤ 750 pascal.
24. The method of any of paragraphs 1-23, where supplying the recycle portion of the flue gas stream includes step (V1) and subsequently step (V2): where step (V1) includes at least one of the following steps: abating particulates present in the flue gas stream; reducing a temperature of the flue gas stream; scrubbing a sulfur-containing material from the flue gas stream; and (V2) obtaining the recycle portion from the flue gas stream.
25. The method of any of paragraphs 1-24, where supplying the recycle portion of the flue gas includes increasing a pressure of the recycle portion before the recycle portion reaches the at least one of: the oxidant stream; the combustion zone; the optional dilution zone; and the heat transfer zone downstream of the combustion zone or the optional dilution zone, or both.
26. The method of any of paragraphs 1-25, where the feed material includes an organic material or a carbonaceous material, or both.
27. The method of any of paragraphs 1-26, where the feed material includes a material that is capable of reacting with molecular oxygen, thereby releasing thermal energy.
28. The method of any of paragraphs 1-27, where the feed material is at least partly converted into a byproduct under operating conditions of the direct-fired kiln, and the byproduct is capable of reacting with molecule oxygen under the operating conditions of the direct-fired kiln, thereby releasing thermal energy.
29. A kiln for calcining a feed material, the kiln including a combustion device; an oxidant supply line configured to supply an oxidant to the combustion device; a fuel line configured to supply a fuel to the combustion device; a combustion zone configured to allow combustion of the fuel in presence of the oxidant to produce a gas mixture; a heat transfer zone having a feed inlet for receiving the feed material, a product outlet for discharging a treated product, a flue gas outlet for discharging a flue gas stream, a proximal end in proximity to the combustion zone for receiving the gas mixture, and a distal end opposite to the proximal end and in proximity to the flue gas outlet; an optional dilution zone between the combustion zone and the heat transfer zone; and a flue gas recycle line configured to supply a recycle portion of the flue gas stream to at least one of (i) the oxidant supply line; (ii) the combustion zone; (iii) the optional dilution zone; and (iv) the heat transfer zone downstream of the combustion zone or the optional dilution zone.
30. The kiln of paragraph 29, where the kiln includes the optional dilution zone, and the flue gas recycle line is configured to supply the recycle portion of the flue gas stream to the optional dilution zone.
31. The kiln of paragraph 29, where the kiln is free of the optional dilution zone, and the flue gas recycle line is configured to supply the recycle portion of the flue gas stream to the heat transfer zone immediately downstream of the combustion zone in a flow direction of the gas mixture.
32. The kiln of paragraph 29, where the kiln includes a rotary heat transfer zone.
33. The kiln of paragraph 32, where the kiln is a counter-current kiln including the feed inlet in proximity to the distal end of the heat transfer zone and in proximity to the flue gas outlet, and the product outlet in proximity to the proximal end of the heat transfer zone, where the proximal end is in proximity to the combustion zone.
34. The kiln of paragraph 33, where the heat transfer zone tilts upwards from the proximal end to the distal end.
35. The kiln of paragraph 32, where the kiln is a co-current kiln, the feed inlet is in proximity to the proximal end of the heat transfer zone, and the product outlet is in proximity to the distal end of the heat transfer zone and in proximity to the flue gas outlet, where the proximal end is in proximity to the combustion zone.
36. The kiln of paragraph 35, where the heat transfer zone tilts downwards from the proximal end to the distal end.
37. The kiln of any of paragraphs 29-36, further including a temperature sensor configured to measure a temperature in the combustion zone, or a temperature sensor configured to measure a temperature in the heat transfer zone, or a temperature sensor configured to measure a temperature in the optional dilution zone, or a combination thereof, and a controller configured to control an amount and/or a flow rate of the recycle portion of the flue gas stream in the flue gas recycle line using at least partly the measured temperature in the combustion zone, or the measured temperature in the heat transfer zone, or the measured temperature in the optional dilution zone, or the combination thereof.
38. The kiln of any of paragraphs 29-37, further including an O₂ sensor configured to measure an O₂ concentration in the combustion zone, or an O₂ sensor configured to measure an O₂ concentration in the heat transfer zone, or an O₂ sensor configured to measure an O₂ concentration in the optional dilution zone, or a combination thereof, and a controller configured to control an amount and/or flow rate of the recycle portion of the flue gas stream in the flue gas recycle line using at least partly the measured O₂ concentration in the combustion zone, or the measured O₂ concentration in the heat transfer zone, or the measured O₂ concentration in the optional dilution zone, or the combination thereof.
39. The kiln of any of paragraphs 29-38, further including a flue gas treatment subsystem in fluid communication with the flue gas outlet and the flue gas recycle line, where the flue gas treatment subsystem includes at least one of the following: a particle removing device configured to abate particulates present in the flue gas stream; a heat exchanger configured to reduce a temperature of the flue gas stream; and a sulfur removing device configured to abate a sulfur-containing material from the flue gas stream.
40. The kiln of paragraphs 29-39, where the flue gas recycle line includes a fan or compressor configured to increase a pressure of the recycle portion before the recycle portion reaches the at least one of: the oxidant stream; the combustion zone; the optional dilution zone; and the heat transfer zone immediately downstream of the combustion zone or the optional dilution zone, or both.

While this disclosure may be susceptible to various modifications and alternative forms, the embodiments discussed above have been shown only by way of example. However, it should again be understood that the disclosure is not intended to be limited to the particular embodiments

disclosed herein. Many alterations, modifications, and variations will be apparent to those skilled in the art in light of the foregoing description without departing from the spirit or scope of this disclosure and that when numerical lower limits and numerical upper limits are listed herein, ranges from any lower limit to any upper limit are contemplated. All numerical values within the detailed description herein are modified by “about” the indicated value, and take into account experimental error and variations that would be expected by a person having ordinary skill in the art. Indeed, this disclosure include all alternatives, modifications, and equivalents falling within the true spirit and scope of the appended claims.

What is claimed is:

1. A method for treating a feed material in a direct-fired kiln comprising a combustion device, a combustion zone, a heat transfer zone, and an optional dilution zone between the combustion zone and the heat transfer zone, the method comprising:
(I) supplying an oxidant stream and a fuel to the combustion device;
(II) combusting the fuel in the combustion zone to produce a gas mixture;
(III) contacting the gas mixture with the feed material in the heat transfer zone;
(IV) withdrawing a flue gas stream from the heat transfer zone at a flue gas outlet; and
(V) supplying a recycle portion of the flue gas stream to at least one of: (a) the oxidant stream; (b) the combustion zone; (c) the optional dilution zone, and (d) the heat transfer zone downstream of the combustion zone and the optional dilution zone.

2. The method of claim 1, wherein the direct-fired kiln comprises the optional dilution zone, and in supplying the recycle portion of the flue gas stream, the recycle portion of the flue gas stream is supplied to at least the optional dilution zone.

3. The method of claim 1, wherein the direct-fired kiln is free of the optional dilution zone, and in step (V), the recycle portion of the flue gas stream is supplied to the heat transfer zone immediately downstream of the combustion zone in a flow direction of the gas mixture.

4. The method of claim 1, wherein the direct-fired kiln comprises a rotary body including the heat transfer zone.

5. The method of claim 4, wherein the direct-fired kiln is a counter-current kiln comprising a feed inlet in proximity to a distal end of the heat transfer zone and in proximity to the flue gas outlet, and a product outlet in proximity to a proximal end of the heat transfer zone, wherein the proximal end is in proximity to the combustion zone or the optional dilution zone.

6. The method of claim 5, wherein the heat transfer zone tilts upward from the proximal end to the distal end.

7. The method of claim 4, wherein the direct-fired kiln is a co-current kiln comprising a feed inlet in proximity to a proximal end of the heat transfer zone, and a product outlet in proximity to a distal end of the heat transfer zone and in proximity to the flue gas outlet, wherein the proximal end is in proximity to the combustion zone or the optional dilution zone.

8. The method of claim 5, wherein the heat transfer zone tilts downward from the proximal end to the distal end.

9. The method of claim 1, wherein the heat transfer zone has an absolute pressure ranging from 95 kilopascals (kPa) to 102 kPa.

10. The method of claim 1, wherein the heat transfer zone has an absolute pressure ranging from P(a) – 249 pascals to P(a), where P(a) is ambient pressure.

11. The method of claim 1, wherein the heat transfer zone operates at an average temperature ranging from T(pd) – 100 °C to T(pd) + 100 °C, wherein T(pd) is a predetermined temperature.

12. The method of claim 1, wherein in step (V), the recycle portion of the flue gas stream has a temperature that is no higher than 300 °C.

13. The method of claim 1, wherein in step (V), the recycle portion of the flue gas stream has a temperature that is no higher than 150 °C.

14. The method of claim 1, wherein in step (V), the recycle portion of the flue gas stream has a temperature that is no higher than 100 °C.

15. The method of claim 1, wherein in step (V), the recycle portion of the flue gas stream has a partial pressure of oxygen that is no higher than 5 kPa.

16. The method of claim 1, wherein in step (V), the recycle portion of the flue gas stream has a partial pressure of oxygen that ranges from 0 to 2 kPa.

17. The method of claim 1, wherein the recycle portion of the flue gas stream has a partial pressure of oxygen that ranges from p(O₂-a) – 750 pascal to p(O₂-a) + 750 pascal, where p(O₂-a) is average partial pressure of oxygen in the recycle portion of the flue gas stream.

18. The method of claim 1, further comprising:
(VI) measuring a temperature in the combustion zone, or a temperature in the heat transfer zone, or a temperature in the optional dilution zone, or any combination thereof; and
(VIII) controlling an amount, or a flow rate, or both, of the recycle portion of the flue gas stream in step (V) according to at least partly the measured temperature, such that a variation of the temperature in the combustion zone is maintained in a predetermined range of deltaT1, or a variation of the temperature in the heat transfer zone is maintained in a predetermined range of deltaT2, or a variation of the temperature in the optional dilution zone is maintained in a predetermined range of deltaT3, or any combination thereof.

19. The method of claim 1, wherein:
during step (I), at least for a duration of one hour, maintaining the supply of the fuel and the supply of the oxidant stream substantially steady.

20. The method of claim 1, wherein:
during step (I), the recycle portion of the flue gas stream is not supplied to the oxidant stream, or the combustion zone, or both.

21. The method of claim 18, wherein at least one of the following is met:
deltaT1 ≤ 100 °C;
deltaT2 ≤ 100 °C; and
deltaT3 ≤ 100 °C.

22. The method of claim 1, further comprising:
(IX) measuring an oxygen (O₂) concentration in the combustion zone, or an O₂ concentration in the heat transfer zone, or an O₂ concentration in the optional dilution zone, or any combination thereof, and
(X) controlling an amount or a flow rate of the recycle portion of the flue gas stream in step (V) according to at least partly the measured O₂ concentration in the combustion zone, or the measured O₂ concentration in the heat transfer zone, or the measured O₂ concentration in the optional dilution zone, or the combination thereof, such that a variation of O₂ concentration in the combustion zone is maintained in a predetermined range of deltap(O₂)1 or a variation of O₂ concentration in the heat transfer zone is maintained in a predetermined range of deltap(O₂)2 or a variation of the O₂ concentration in the optional dilution zone is maintained in a predetermined range of deltap(O₂22)3.

23. The method of claim 22, wherein at least one of the following is met:
deltap(O₂)1 ≤ 750 pascal;
deltap(O₂)2 ≤ 750 pascal; and
deltap(O₂)3 ≤ 750 pascal.

24. The method of claim 1, wherein step (V) comprises step (V1) and subsequently step (V2):
wherein step (V1) comprises at least one of the following steps:
abating particulates present in the flue gas stream;
reducing a temperature of the flue gas stream;
scrubbing a sulfur-containing material from the flue gas stream; and
(V2) obtaining the recycle portion from the flue gas stream.

25. The method of claim 1, wherein step (V) comprises:
(V3) increasing a pressure of the recycle portion before the recycle portion reaches the at least one of: the oxidant stream; the combustion zone; the optional dilution zone; and the heat transfer zone downstream of the combustion zone or the optional dilution zone, or both.

26. The method of claim 1, wherein the feed material comprises an organic material or a carbonaceous material, or both.

27. The method of claim 1, wherein the feed material comprises a material that is capable of reacting with molecular oxygen, thereby releasing thermal energy.

28. The method of claim 1, wherein the feed material is at least partly converted into a byproduct under operating conditions of the direct-fired kiln, and the byproduct is capable of reacting with molecule oxygen under the operating conditions of the direct-fired kiln, thereby releasing thermal energy.

29. A kiln for treating a feed material, the kiln comprising:
a combustion device;
an oxidant supply line configured to supply an oxidant to the combustion device;
a fuel line configured to supply a fuel to the combustion device;
a combustion zone configured to allow combustion of the fuel in presence of the oxidant to produce a gas mixture;
a heat transfer zone having a feed inlet for receiving the feed material, a product outlet for discharging a treated product, a flue gas outlet for discharging a flue gas stream, a proximal end in proximity to the combustion zone for receiving the gas mixture, and a distal end opposite to the proximal end and in proximity to the flue gas outlet;
an optional dilution zone between the combustion zone and the heat transfer zone; and
a flue gas recycle line configured to supply a recycle portion of the flue gas stream to at least one of (i) the oxidant supply line; (ii) the combustion zone; (iii) the optional dilution zone; and (iv) the heat transfer zone downstream of the combustion zone or the optional dilution zone.

30. The kiln of claim 29, wherein the kiln comprises the optional dilution zone, and the flue gas recycle line is configured to supply the recycle portion of the flue gas stream to the optional dilution zone.

31. The kiln of claim 29, wherein the kiln is free of the optional dilution zone, and the flue gas recycle line is configured to supply the recycle portion of the flue gas stream to the heat transfer zone immediately downstream of the combustion zone in a flow direction of the gas mixture.

32. The kiln of claim 29, wherein the kiln comprises a rotary heat transfer zone.

33. The kiln of claim 32, wherein the kiln is a counter-current kiln comprising the feed inlet in proximity to the distal end of the heat transfer zone and in proximity to the flue gas outlet, and the product outlet in proximity to the proximal end of the heat transfer zone, wherein the proximal end is in proximity to the combustion zone.

34. The kiln of claim 33, wherein the heat transfer zone tilts upwards from the proximal end to the distal end.

35. The kiln of claim 32, wherein the kiln is a co-current kiln, the feed inlet is in proximity to the proximal end of the heat transfer zone, and the product outlet is in proximity to the distal end of the heat transfer zone and in proximity to the flue gas outlet, wherein the proximal end is in proximity to the combustion zone.

36. The kiln of claim 35, wherein the heat transfer zone tilts downwards from the proximal end to the distal end.

37. The kiln of claim 29, further comprising:
a temperature sensor configured to measure a temperature in the combustion zone, or a temperature sensor configured to measure a temperature in the heat transfer zone, or a temperature sensor configured to measure a temperature in the optional dilution zone, or a combination thereof, and
a controller configured to control an amount, or a flow rate, or both, of the recycle portion of the flue gas stream in the flue gas recycle line using at least partly the measured temperature in the combustion zone, or the measured temperature in the heat transfer zone, or the measured temperature in the optional dilution zone, or the combination thereof.

38. The kiln of claim 29, further comprising:
an O₂ sensor configured to measure an O₂ concentration in the combustion zone, or an O₂ sensor configured to measure an O₂ concentration in the heat transfer zone, or an O₂ sensor configured to measure an O₂ concentration in the optional dilution zone, or a combination thereof, and
a controller configured to control an amount, or flow rate, or both, of the recycle portion of the flue gas stream in the flue gas recycle line using at least partly the measured O₂ concentration in the combustion zone, or the measured O₂ concentration in the heat transfer zone, or the measured O₂ concentration in the optional dilution zone, or the combination thereof.

39. The kiln of claim 29, further comprising:
a flue gas treatment subsystem in fluid communication with the flue gas outlet and the flue gas recycle line, wherein the flue gas treatment subsystem comprises at least one of the following:
a particle removing device configured to abate particulates present in the flue gas stream;
a heat exchanger configured to reduce a temperature of the flue gas stream; and
a sulfur removing device configured to abate a sulfur-containing material from the flue gas stream.

40. The kiln of claim 29, wherein the flue gas recycle line comprises a fan or compressor configured to increase a pressure of the recycle portion before the recycle portion reaches the at least one of: the oxidant stream; the combustion zone; the optional dilution zone; and the heat transfer zone immediately downstream of the combustion zone or the optional dilution zone, or both.
